(19) United States
(12) Patent Application Publication
(10) Pub. No.: US 2004/0264584 A1
(43) Pub. Date: Dec. 30, 2004

(54) Method and apparatus for estimating frequency offsets for an OFDM burst receiver

(76) Inventors: Jonathan F. Labs, Montreal (CA); Stephane Gagnon, Laval (CA); Erick Delage, Beaconsfield (CA)

Correspondence Address: OGILVY RENAULT, 1981 MCGILL COLLEGE AVENUE, SUITE 1600, MONTREAL, QC, H3A2Y3, CA

(21) Appl. No.: 10/601,535

(22) Filed: Jun. 24, 2003

(51) Int. Cl. H04K 1/10

(52) U.S. Cl. 375/260

(57) ABSTRACT

A method and apparatus is disclosed for correcting a frequency offset in a received OFDM signal comprising estimating a fractional frequency offset, removing the fractional frequency offset, estimating an integer frequency offset and removing the integer frequency offset.

### CROSS-REFERENCE TO RELATED APPLICATIONS

This is the first application filed for the present invention.

### TECHNICAL FIELD

This invention relates to the field of telecommunications. More precisely, this invention pertains to the field of estimating a frequency offset between a transmitted signal and a received signal.

### BACKGROUND OF THE INVENTION

Orthogonal Frequency Division Multiplexing (OFDM) is a bandwidth efficient signaling scheme that was first proposed by Chang in 1966.

In OFDM, a plurality of orthogonal carriers, also referred to as sub-carriers, are used in order to modulate a signal to transmit. The plurality of orthogonal carriers is very closely spaced in frequency and the symbol rate of each carrier is very low giving it a narrow bandwidth.

As known by the one skilled in the art, it is possible to remove intersymbol interferences (ISI) and inter-carrier interferences (ICI) by inserting between the symbols a small interval of time referred to as a guard interval.

However, it is also well known that OFDM is very sensitive to frequency offset in a channel. In order to overcome the frequency offset, Coded OFDM (COFDM) has been developed.

In fact, it is also well known that the frequency offset causes a reduction of signal amplitude in the output of each filter matching each of the plurality of carriers as well as introduction of inter-carrier interferences (ICI) by other carriers that are no longer orthogonal to the filter.

There is therefore a need for a method and apparatus that will overcome the above-identified drawbacks.

### SUMMARY OF THE INVENTION

It is an object of the invention to provide a method for removing a frequency offset between a transmitted signal and a received signal.

Yet another object of the invention is to provide an apparatus for removing a frequency offset between a transmitted signal and a received signal.

According to a first aspect of the invention, there is provided, in an OFDM receiver, a method for removing a frequency offset between a transmitted signal and a received signal, the frequency offset comprising a fractional portion and an integer portion, the method comprising estimating the fractional portion of the frequency offset, removing the fractional portion of the frequency offset, whereby only the integer frequency offset remains between the transmitted signal and the received signal, estimating the integer portion of the frequency offset and removing the integer portion of the frequency offset, thereby removing the frequency offset between the transmitted signal and the received signal.

According to another aspect of the invention, there is provided, in an OFDM receiver, a frequency offset removing apparatus, for removing a frequency offset between a transmitted signal and a received signal, the frequency offset comprising a fractional portion and an integer portion, the apparatus comprising a fractional frequency offset estimation unit receiving the transmitted signal and estimating the fractional portion of the frequency offset to provide a first signal, a fractional frequency offset removing unit receiving the transmitted signal and the first signal and removing the fractional portion of the frequency offset to provide a second signal, whereby only the integer frequency offset remains between the transmitted signal and the received signal, an integer frequency offset determining unit receiving the second signal and estimating the integer portion of the frequency offset in the second signal to provide a third signal and an integer frequency offset removing unit receiving the third signal and removing the integer portion of the frequency offset in the third signal, thereby removing the frequency offset between the transmitted signal and the received signal.

### BRIEF DESCRIPTION OF THE DRAWINGS

Further features and advantages of the present invention will become apparent from the following detailed description, taken in combination with the appended drawings, in which:

FIG. 1 is a diagram which shows a plurality of sub-carriers 1 to n for an OFDM signal having a bandwidth B;

FIG. 2a is a graph which shows an OFDM signal comprising a plurality of sub-carriers in the time domain while FIG. 2b shows the OFDM signal comprising the plurality of sub-carriers in the frequency domain;

FIG. 3 is a graph which shows a frequency shift and inter-carrier interferences in a received OFDM signal comprising the plurality of sub-carriers in the frequency domain;

FIG. 4 is a block diagram which shows the preferred embodiment of one part of an OFDM receiver according to the preferred embodiment of the invention;

FIG. 5 is a flowchart which shows the preferred embodiment of the invention, a fractional frequency offset is estimated, the fractional frequency offset estimated is removed from a received signal, an integer frequency offset is estimated and the integer frequency offset is removed;

FIG. 6a is a graph which shows an example of the plurality of sub-carriers in the case where a frequency offset of 3.35 times a sub-carrier separation occurs; the frequency offset comprises a fractional frequency offset and an integer frequency offset;

FIG. 6b is a graph which shows the plurality of sub-carriers observed after removing the fractional frequency offset of the frequency offset; and

FIG. 6c is a graph which shows the plurality of sub-carriers after further removing the integer frequency offset of the frequency offset;

FIG. 7 is a flowchart which shows how an ambiguity, which may arise in boundaries conditions, in the case of noise, is lifted.

It will be noted that throughout the appended drawings, like features are identified by like reference numerals.

### DETAILED DESCRIPTION OF THE PREFERRED EMBODIMENT

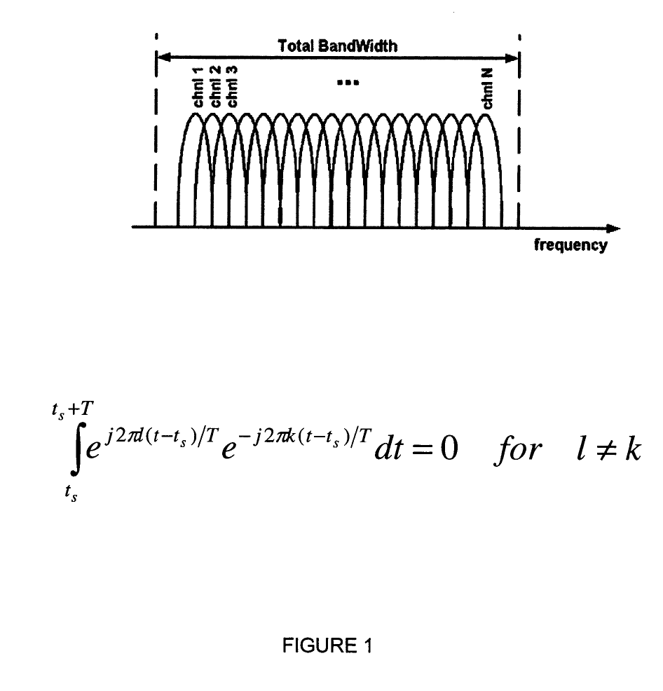

Now referring to FIG. 1, there is shown a plurality of sub-carriers 1 to n for an OFDM signal having a bandwidth B. Someone skilled in the art will appreciate that, as opposed to Frequency Division Multiplexing (FDM), sub-carriers overlap. Each respective sub-carrier of the plurality of sub-carriers is placed at the zero-points of the other sub-carriers in order to avoid the inter-carrier interferences (ICI).

Still referring to FIG. 1, there is shown the orthogonality condition that is met by the plurality of sub-carriers. In fact each sub-carrier of the plurality of sub-carriers is orthogonally spaced in frequency in order to avoid mutual interferences.

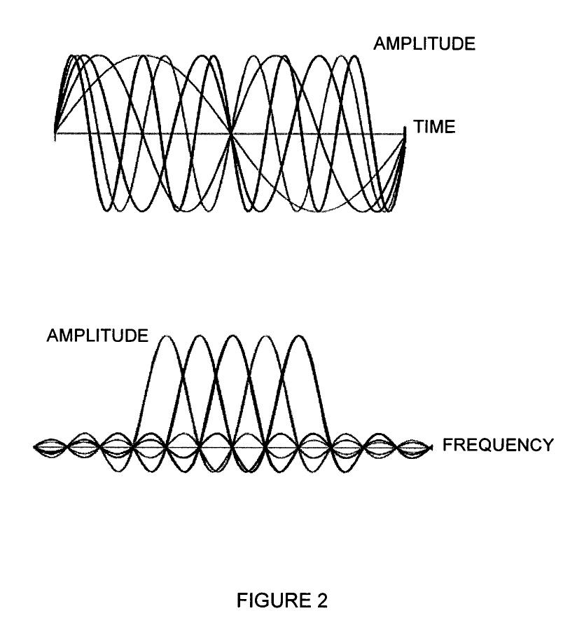

Now referring to FIG. 2a, there is shown a graph which shows an OFDM signal comprising a plurality of sub-carriers in the time domain while FIG. 2b shows the OFDM signal comprising the plurality of sub-carriers in the frequency domain.

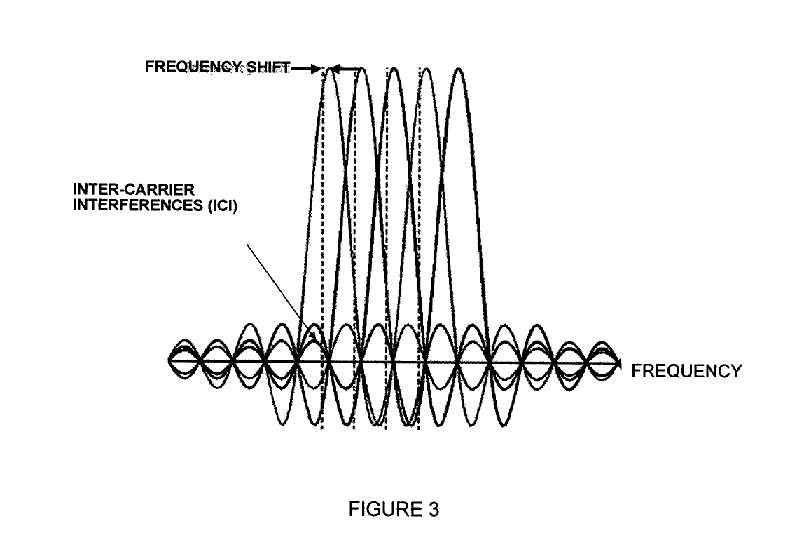

Now referring to FIG. 3, there is shown a received OFDM signal in the case where a frequency shift occurred. The frequency shift offset which occurred creates inter-carrier interferences (ICI). When normalized to the sub-carrier frequency separation, the frequency shift offset comprises a fractional frequency offset and an integer frequency offset.

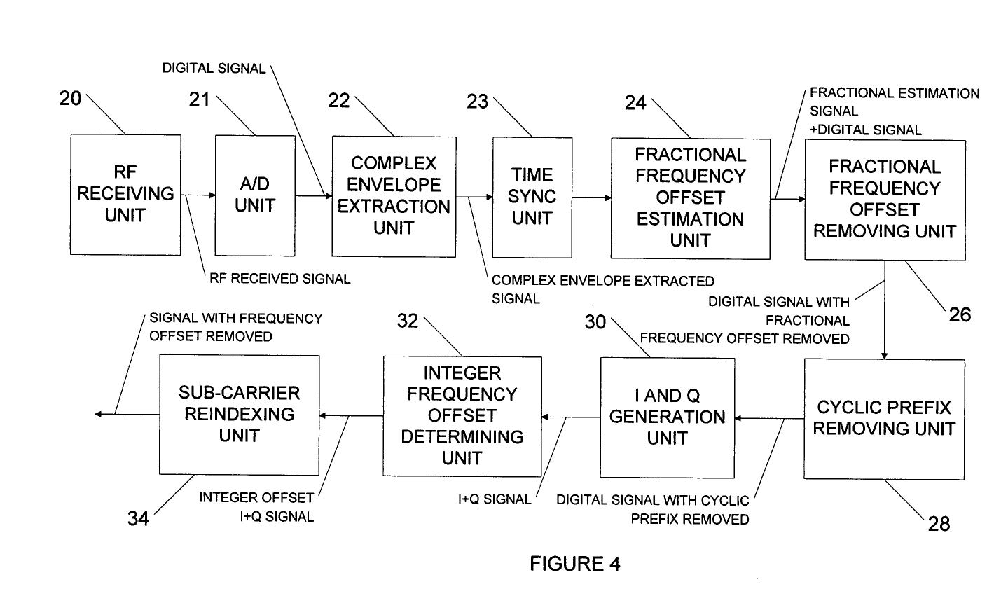

Now referring to FIG. 4, there is shown a block diagram of one part of an OFDM receiver according to the preferred embodiment of the invention. The receiver comprises an RF receiving unit 20, an analog to digital (A/D) unit 21, a complex envelope extraction unit 22, a time synchronizing unit 23, a fractional offset estimation unit 24, a fractional frequency offset removing unit 26, a cyclic prefix removing unit 28, an I and Q generation unit 30, an integer frequency offset determining unit 32 and a sub-carrier reindexing unit 34.

The RF receiving unit 20 receives an RF signal and provides an RF received signal to the analog to digital (A/D) unit 21. The received RF signal has a complex envelope which is s_{R}(t)=s_{T}(t)e^{j2πΔf}^{_{c}}^{t}, where s_{T}(t) is the complex envelope of a transmitted OFDM signal and Δf_{c} is the frequency offset.

The analog to digital unit 21 digitizes the RF received signal and provides a digital signal to the complex envelope extraction unit 22.

The complex envelope extraction unit 22 extracts the complex envelope of the digital signal. Such extraction is referred to as I/Q demodulation by someone skilled in the art.

The complex envelope extraction unit 22 provides a complex envelope extracted signal to the time synchronizing unit 23. The time synchronizing unit 23 locates the beginning of an OFDM symbol. Preferably, the reference symbol or the preamble of the OFDM symbol is located by the time synchronizing unit 23. The time synchronizing unit 23 provides the localized beginning of an OFDM symbol together with the digital signal to the fractional frequency offset estimation unit 24.

Still in the preferred embodiment of the invention, the complex envelope extraction unit 22 is a digital I/Q demodulation unit.

The complex envelope of the received RF signal is digitized, by the analog to digital unit 21, at interval t=nΔt and the digitized complex envelope of the received RF signal is S_{R}(t)|_{t=nΔt}=s_{T}(t)e^{j2πΔf}^{_{c}}^{t}|_{t=nΔt} n=0,1,2, . . .

The digitized complex envelope of the digital signal may be further expressed as s_{R}(nΔt)=s_{T}(nΔt)e^{j2πΔf}^{_{c}}^{nΔt} n=0,1,2, . . . where Δt is the duration of a digitized sample.

In the case where x(n)≡s(nΔt), the expression of the digitized complex envelope of the digital signal becomes x_{R}(n)=x_{T}(n)e^{j2πΔf}^{_{c}}^{nΔt} n=0,1,2, . . .

In the case where N′ samples are repeated N samples later, x_{T}(n)=x_{T}(n−N) for N≦n≦N+N′−1.

In the case where N′ samples are repeated N samples later, the expression of the digitized complex envelope becomes x_{R}(n′)=x_{T}(n′)e^{j2πΔf}^{_{c}}^{n′Δt} for N≦n′≦N+N′−1 or therefore

x_{R}(n+N)=x_{T}(n+N)e^{j2πΔf}^{_{c}}^{(n+N)Δt} for 0≦n≦N′−1 or finally x_{R}(n+N)=x_{T}(n)e^{j2πΔf}^{_{c}}^{(n+N)Δt} for 0≦n≦N′−1.

Using previous equation, it is possible to compute x_{R}(n)x*_{R}(n+N)=└x_{T}(n)e^{j2πΔf}^{_{c}}^{nΔt} [symbol] x_{T}(n)e^{j2πΔf}^{_{c}}^{(n+N)Δt}┘* for 0≦n≦N′−1, which may simplify into x_{R}(n)x*_{R}(n+N)=x_{T}(n)x*_{T}(n)e^{j(2πΔf}^{_{c}}^{nΔt-2πΔf}^{_{c}}^{(n+N)Δt)} for 0≦n≦N′−1 and finally into x_{R}(n)x*_{R}(n+N)=|x_{T}(n)|²e^{-j(2πΔf}^{_{c}}^{NΔt)} for 0≦n≦N′−1.

As the later exponential term is independent of n, it is possible to perform a sum of the latter equation

$$\begin{matrix}X ( ϵ ) ≡ {\sum }_{n = 0}^{{N}^{′} - 1} {x}_{R} ( n ) {x}_{R}^{*} ( n + N ) \\ = {ⅇ}^{- jϵ} {\sum }_{n = 0}^{{N}^{′} - 1} {\vert {x}_{T} ( n ) \vert}^{2}\end{matrix} , where ϵ = 2 πΔ {f}_{c} N Δ t .$$

The phase of the digitized signal is therefore equal to arctan(X(ε)).

$${ϵ}^{′} = arctan ( \frac{Im ( X )}{Re ( X )} ) .$$

As there is no one to one relation between ε′ and ε, it is possible to state that ε=ε′+2πk, where k is an integer.

As known by someone skilled in the art, in an OFDM symbol, a cyclic prefix is generated in the transmitter by copying the Npre samples from the end of the symbol and appending them to the beginning of a symbol. It will therefore be appreciated that those samples may therefore be used to determine ε′. In this case N is equal to the number of points in the Discrete Fourier Transform (DFT) and

$$\begin{matrix}\frac{1}{N Δ t} = \frac{{f}_{s}}{{N}_{Dft}} \\ = Δ f\end{matrix}$$

where Δf is the sub-carrier separation.

Given previous equations, it can be shown that

$$\frac{Δ {f}_{c}}{Δ f} = \frac{{ϵ}^{′}}{2 π} + k$$

The frequency offset is therefore

$$Δ {f}_{c} = ( \frac{{ϵ}^{′}}{2 π} + k ) \frac{1}{N Δ t} .$$

As explained above, the frequency offset is therefore divided into the fractional frequency offset, which is equal to

$$\frac{{ϵ}^{′}}{2 π} ,$$

and the integer frequency offset which is equal to k.

According to step 36, a fractional frequency offset is estimated. The fractional frequency offset is estimated using the fractional frequency offset estimation unit 24 which receives the digital signal. More precisely, the fractional frequency offset of the frequency offset is estimated by computing

$$\frac{{ϵ}^{′}}{2 π}$$

where

$${ϵ}^{′} = arctan ( \frac{Im ( X )}{Re ( X )} ) .$$

The estimated fractional frequency offset and the digital signal are provided to the fractional frequency offset removing unit 26. The fractional frequency offset removing unit 26 provides the digital signal with the fractional frequency offset removed to the cyclic prefix removing unit 28.

In the preferred embodiment of the invention, the fractional frequency offset is removed by introducing a phase correction factor to the received samples

$${x}_{R}^{′} ( n ) = {x}_{R} ( n ) {ⅇ}^{- j \frac{{ϵ}^{′} n}{N}} n = 0 , 1 , 2 , … .$$

Someone skilled in the art will appreciate that after removing the fractional frequency offset, the Inter-Carrier Interference (ICI) will be removed.

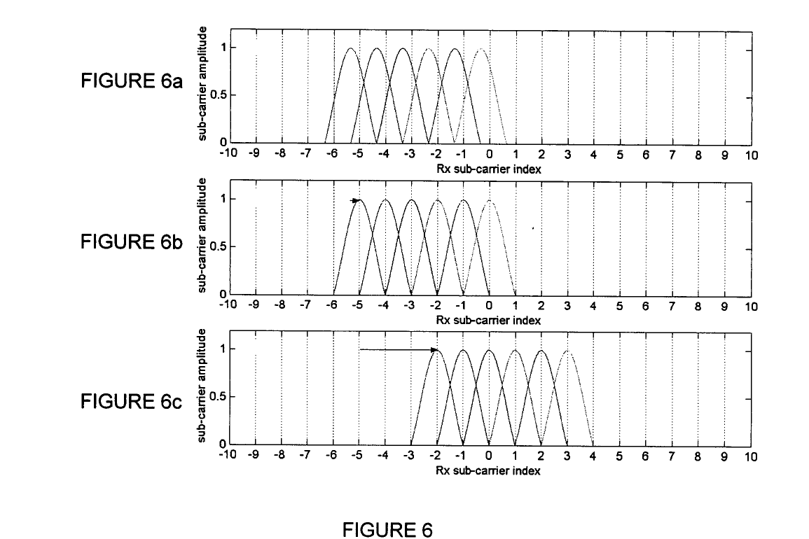

Now referring to FIG. 6a, there is shown a graph which shows an example of a plurality of sub-carriers observed at the receiver with a frequency offset of 3.35 times the sub-carrier separation. In such case, the fractional frequency offset is 0.35 and the integer frequency offset is 3. It will be appreciated that in an alternative embodiment, the fractional frequency offset may be −0.65 and the integer frequency offset may be 4.

Now referring to FIG. 6b, there is shown a graph which shows the plurality of sub-carriers observed at the receiver in the case where the fractional frequency offset of 0.35 is removed.

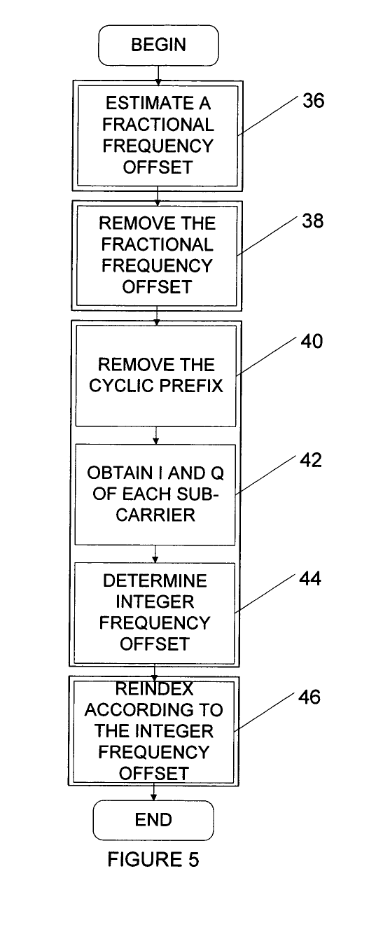

Now referring back to FIG. 5 and according to step 40, the cyclic prefix is removed from the digital signal with the fractional frequency offset removed. The cyclic prefix is removed using the cyclic prefix removing unit 28.

The cyclic prefix removing unit 28 provides a digital signal with the cyclic prefix removed.

According to the step 42 of FIG. 5, I and Q are obtained. In the preferred embodiment of the invention, the I and Q are obtained using the I and Q generation unit 30. In the preferred embodiment of the invention the I and Q are determined by applying a Fast-Fourier Transform (FFT) on the provided digital signal with the cyclic prefix removed.

An I and Q signal is provided by the I and Q generation unit 30.

According to step 44, the integer frequency offset k is determined. The integer frequency offset k is determined using the integer frequency offset determining unit 32.

In the preferred embodiment of the invention, the integer frequency offset is determined by locating a “start point” and comparing it to an expected value in order to determine a shift in frequency.

The integer frequency offset k is therefore determined by detecting how much shift, in the frequency domain, is required in order that a transmitted sub-carrier and a received sub-carrier are aligned together.

Still in the preferred embodiment of the invention, the detecting of the integer frequency offset k is performed by synchronizing the I and Q signal provided by the I and Q generation unit 30 with a sequence of known coefficients.

In the preferred embodiment, the synchronizer used is disclosed in a pending US Patent Application entitled “Synchronizing method and apparatus” that is concurrently filed, the specification of which is herewith enclosed by reference. Still in the preferred embodiment the sequence of known coefficients used is the beginning of a burst frame. The sequence of known coefficients may also be referred to as the reference symbol or the OFDM preamble.

The integer frequency offset determining unit 32 provides the I and Q signal and the integer frequency offset signal.

According to step 46, the I and Q signal is re-indexed using the integer frequency offset signal provided by the integer frequency offset determining unit 32. It will be appreciated that the I and Q signal may be re-indexed by either writing the I and Q signal into a buffer and reading out the buffer with an offset, in the address, determined according to the determined integer frequency offset signal or alternatively by adding a delay when clocking the I and Q signal, where the delay is determined according to the integer frequency offset signal.

Now referring to FIG. 6c, there is shown a graph which shows an example of the plurality of sub-carriers in the case where the integer frequency offset of 3 is removed.

In the case where there is noise and where the fractional frequency offset is in the vicinity of ½ the carrier spacing, the computed value for ε′ may jump between −π and +π.

It will therefore be appreciated that such effect may cause the integer frequency offset removing unit 32 to give a data symbol of the integer frequency offset k which would be shifted by +−1 sub-carrier compared to the integer frequency offset determined from the reference symbol.

In order to solve such a problem, it is necessary to move the boundary of ambiguity according to the fractional frequency offset measured for the reference symbol.

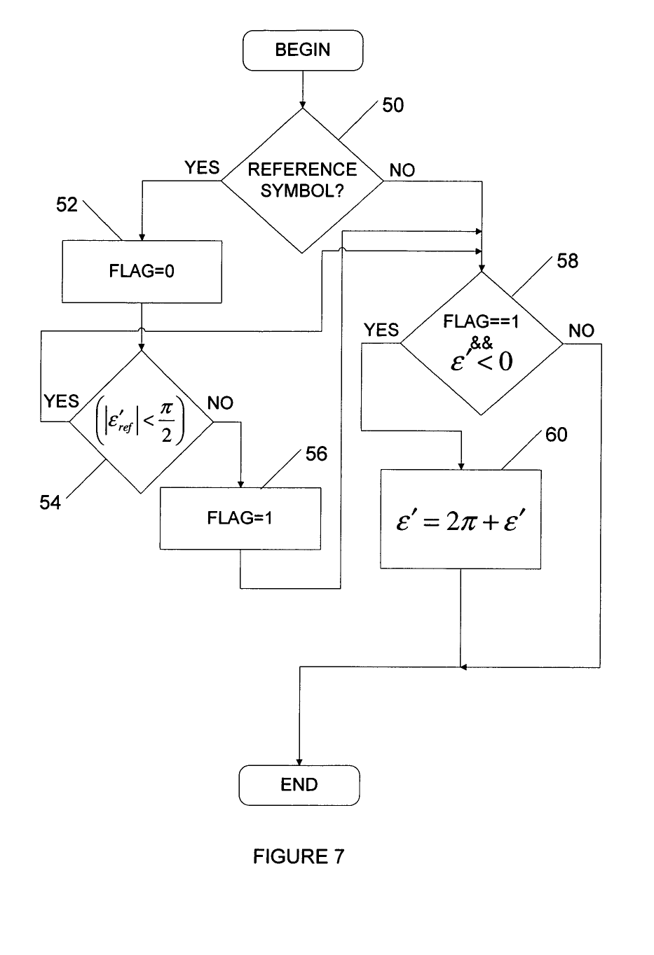

Now referring to FIG. 7, there is shown how such ambiguity is lifted in the preferred embodiment.

According to step 50 a test is performed in order to find out if a symbol is a reference symbol.

In the case where the symbol is a reference symbol and according to step 52, a flag is set to 0.

According to step 54, a test is performed in order to find out if

$$\vert {ϵ}_{ref}^{′} \vert < \frac{π}{2} .$$

In the case where this is not the case and according to step 56, the flag is set to 1.

According to step 58, a test is performed in order to find out if the flag is equal to one and if the symbol is smaller than zero.

It will be appreciated that step 58 is performed if the symbol is not a reference symbol, if

$$\vert {ϵ}_{ref}^{′} \vert < \frac{π}{2}$$

is not true and after completing step 56.

If the conditions of the test of step 58 are met and according to step 60, ε′=2π+ε′.

It is known that Cordic rotators have been implemented in order to replace operations of the arctan, sine and cosine functions required for correcting the fractional frequency offsets. The Cordic rotator also generates angles in the range [−π,π].

It has been contemplated that implementation of such logic in fixed-point arithmetic has an elegant solution in the case where the following representation is used.

π=0×7FFF

$$- π = 0 \times 8000 if \vert {ϵ}_{ref}^{′} \vert < \frac{π}{2}$$

and

0=0×0000

$$2 π \approx O \times FFFF if \vert {ϵ}_{ref}^{′} \vert \geq \frac{π}{2} .$$

Someone skilled in the art will therefore appreciate that signed complement-2 notation is used in the former condition while unsigned complement-2 notation is used in the latter condition.

The consequence of such notation may be appreciated when computing ε′/1024. Such computation is performed by removing the 10 last significant bits. Using still 16 bits to represent the resulting angle, the representation determines whether that number is to be sign extended or not. Upon such determination, the number may then finally interpreted as signed complement-2 when generating sin(nε′/1024) and cos(nε′/1024) for n=0 to 1023.

The embodiments of the invention described above are intended to be exemplary only. The scope of the invention is therefore intended to be limited solely by the scope of the appended claims.

We claim:

1. In an OFDM receiver, a method for removing a frequency offset between a transmitted signal and a received signal, said frequency offset comprising a fractional portion and an integer portion, said method comprising:
estimating said fractional portion of said frequency offset;
removing said fractional portion of said frequency offset, whereby only said integer frequency offset remains between said transmitted signal and said received signal;
estimating said integer portion of said frequency offset; and
removing said integer portion of said frequency offset, thereby removing said frequency offset between said transmitted signal and said received signal.

2. The method as claimed in claim 1, further comprising detecting I and Q for each sub-carrier of said received signal prior to performing said estimating of said integer portion of said frequency offset to provide an I and Q sequence signal, further wherein said estimating of said integer portion of said frequency offset is performed by synchronizing said I and Q sequence signal with a sequence of known coefficients.

3. The method as claimed in claim 2, wherein said synchronizing comprises detecting said sequence of known coefficients in said I and Q sequence signal.

4. The method as claimed in claim 1, wherein said removing of said fractional portion of said frequency offset is performed by multiplying said received signal with a phase correlation factor comprising said fractional frequency offset.

5. The method as claimed in claim 1, wherein said transmitted signal comprises a cyclic prefix, further comprising removing said cyclic prefix in said received signal.

6. The method as claimed in claim 2, wherein said detecting of said I and Q is performed using a Discrete Fourier Transform (DFT).

7. In an OFDM receiver, a frequency offset removing apparatus, for removing a frequency offset between a transmitted signal and a received signal, said frequency offset comprising a fractional portion and an integer portion, said apparatus comprising:
a fractional frequency offset estimation unit receiving said transmitted signal and estimating said fractional portion of said frequency offset to provide a first signal;
a fractional frequency offset removing unit receiving said transmitted signal and said first signal and removing said fractional portion of said frequency offset to provide a second signal, whereby only said integer frequency offset remains between said transmitted signal and said received signal;
an integer frequency offset determining unit receiving said second signal and estimating said integer portion of said frequency offset in said second signal to provide a third signal; and
an integer frequency offset removing unit receiving said third signal and removing said integer portion of said frequency offset in said third signal, thereby removing said frequency offset between said transmitted signal and said received signal.

8. The apparatus as claimed in claim 7, wherein said apparatus further comprises a I and Q generation unit detecting I and Q for each sub-carrier of said second signal and providing an I and Q sequence signal, further wherein said integer frequency offset determining unit performs a synchronization of said I and Q sequence signal with a sequence of known coefficients.

9. The apparatus as claimed in claim 8, wherein said synchronizing comprises detecting said sequence of known coefficients in said I and Q sequence signal.

10. The apparatus as claimed in claim 7, wherein said fractional frequency offset removing unit multiplies said received signal with a phase correlation factor comprising said fractional frequency offset.

11. The apparatus as claimed in claim 7, wherein said transmitted signal comprises a cyclic prefix, further wherein said apparatus comprises a cyclic prefix removing unit removing said cyclic prefix of said received signal.
